(19) United States
(12) Patent Application Publication
(10) Pub. No.: US 2010/0034730 A1
(43) Pub. Date: Feb. 11, 2010

(54) One-step, paste-state mechanochemical process for the synthesis of zinc oxide nanoparticles

(75) Inventors: Jun Lu, Lanzhou (CN); Ka Ming Ng, Clear Water Bay (HK); Shihe Yang, Clear Water Bay (HK); Jiyun Feng, Tseung Kwan O (HK)

Correspondence Address: THE NATH LAW GROUP, 112 South West Street, Alexandria, VA, 22314, US

(73) Assignee: The Hong Kong University of Science and Technology, Clear Water Bay (HK)

(21) Appl. No.: 12/149,459

(22) Filed: May 1, 2008

Related U.S. Application Data
(60) Provisional application No. 60/924,118, filed on May 1, 2007.

(51) Int. Cl. C01G 9/02

(52) U.S. Cl. 423/622; 977/773; 977/811

(57) ABSTRACT

The present subject matter provides a time- and energy-saving paste-state mechanochemical process to synthesize zinc oxide nanoparticles. Our nanoparticles are small, have abundant surface hydroxyl groups and exhibit excellent UV blocking characteristics. One embodiment involves a process for preparing zinc oxide nanoparticles comprising grinding, milling, or a combination thereof a mixture comprising (a) at least one zinc salt, (b) at least one additional inorganic salt, and (c) at least one alkali hydroxide compound.

This application claims the benefit of U.S. Provisional Application No. 60/924,118 filed May 1, 2007. The aforementioned provisional application's disclosure is incorporated herein by reference in its entirety.

### FIELD OF THE SUBJECT MATTER

This subject matter relates to the preparation of zinc oxide nanoparticles by a paste-state mechanochemical process. The present subject matter provides a time- and energy-saving paste-state mechanochemical process to synthesize zinc oxide nanoparticles. Nanoparticles of this subject matter are small, have abundant surface hydroxyl groups and exhibit excellent UV blocking characteristics. One embodiment involves a process for preparing zinc oxide nanoparticles comprising grinding, milling, or a combination thereof a mixture comprising (a) at least one zinc salt, (b) at least one additional inorganic salt, and (c) at least one alkali hydroxide compound. In some embodiments, nanoparticles can be manufactured by a one-step method in 30 minutes.

### BACKGROUND OF THE SUBJECT MATTER

Semiconductor nanocrystals have been receiving much attention because of their special properties in comparison with bulk materials. In particular, ZnO is an important group II-VI semiconductor with wide band gap (3.37 eV) and large exciton binding energy of 60 meV at room temperature (D. C. Reynolds et al., J. Appl. Phy. 88, 2152 (2000)). And ZnO nanocrystals have shown considerable potential as the material for light emitting diodes, transparent conductive films, solar cells and UV-blocker (J. H. Lim et al., Adv. Mater. 18, 2720 (2006); M. T. Mohammad et al., Mater. Chem. Phys 99, 382 (2006); A. B. G. Lansdown et al., Int. J. Cosmet. Sci. 19, 167 (1997)).

Known production processes for these zinc oxide nanostructured materials are roughly classified into liquid phase processes, gas phase processes, and mechanochemical processes.

In a liquid phase process, zinc oxalate, zinc hydroxide or basic zinc carbonate is synthesized, precipitated, separated by filtration with a rinse and then thermally decomposed to obtain zinc oxide. The powder obtained has a specific surface area of 50 m²/g or higher (U.S. Pat. No. 6,171,580; U.S. Pat. No. 5,527,519; L. Wang et al., J. Mater. Chem., 9, 2871 (1999); F. A. Sigoli et al., J. Alloys Compd., 262-263, 292 (1997)). The drawback of a liquid phase process is that it is a two-step process. Calcination of the precipitated precursor at 300 to 600° C. gives the heavily aggregated nanostructured ZnO materials in nanoparticles, nanorods or nanoplates. In practical use, zinc oxide must be slurried together with liquids as in the case of paints, pigments, cosmetics, etc. It is essential that the ZnO nanoparticles be incorporated in or compounded with other solids as in the case of reinforcing materials for rubbers and plastics, or mixed with other powders as in the case of materials for electronic components. In these cases, the existence of aggregated particles considerably deteriorates the uniformity in composition or dispersibility.

The typical gas phase process includes a French process of oxidizing zinc vapor and an American process of oxidizing zinc vapor generated at the smelting process of zinc ore (U.S. Pat. No. 6,416,862; U.S. Pat. No. 6,335,002; U.S. Pat. No. 5,527,519; U.S. Pat. No. 5,560,871; U.S. Pat. No. 5,582,771; S. Mahmud et al., J. Cryst. Growth 287, 118 (2006)). The so-called French process comprises oxidation of zinc metal vapor by mixing with air and quenching with excess air. The particle size of the resulting zinc oxide can be decreased by increasing the rate of mixing and quenching. However, the process inevitably produces a proportion of unreacted zinc metal in the zinc oxide product, and the smaller the particle size of the oxide product the higher the level of zinc metal impurity. Zinc metal is an extremely undesirable impurity, particularly when the zinc oxide contaminated with, it is to be used in products such as sunscreens, paints, plastics etc., because it is capable of reaction with air, moisture and organic media to generate undesirable gaseous products. In addition, zinc tends to impart a grey tinge to the product which is aesthetically undesirable, and is often coarser than the zinc oxide thereby tending to impart a gritty feel to the product. The American process may happen to produce needle-shaped zinc oxide. However, this process has a problem in purity since toxic compounds such as lead, cadmium, etc. tend to be contained in the product.

Both French and American processes are highly energy intensive. For example, in U.S. Pat. No. 6,416,862, the zinc vapor-containing gas has a temperature of about 950° C. or higher at a nozzle of the reactor for discharging the zinc vapor-containing gas and the oxidizing gas has a temperature of about 900° C. or higher at a nozzle of the reactor for discharging the oxidizing gas. In U.S. Pat. No. 6,335,002, the temperature at the time of jetting out the zinc vapor from a first nozzle together with an inert gas as the carrier gas is about 1,000 to 1,500° C. The temperature at the time of jetting out the oxidizing gas containing oxygen and water vapor from a second or third nozzle is about 1,000 to 1,200° C. These high energy-consuming processes are not ideal processes in a world facing energy crisis.

In U.S. Pat. No. 6,503,475, a process is disclosed for producing ZnO nanoparticles by milling basic zinc carbonate with NaCl in one step followed by a subsequent calcination process step. A few publications report the synthesis of ZnO nanoparticles by mechanochemical method. According to the publications, the mechanochemical process for the synthesis of ZnO nanoparticles can be divided into three different classes:

I: Milling of a mixture of ZnCO₃.2Zn(OH)₂ and sodium chloride and then the calcination of the milled powder mixture as a multi-step process (U.S. Pat. No. 6,503,475)
II: Preparing ZnO nanoparticles via mechanochemical reaction of ZnCl₂+Na₂CO₃=ZnCO₃+2NaCl and subsequent thermal decomposition of ZnCO₃ with the addition of NaCl as a multi-step process (T. Tsuzuki et al., Scripta Mater. 44, 1731 (2001); H. M. Yang et al., Mater. Sci. Technol. 20, 1493 (2004)).
III: Grinding of a zinc acetate-oxalic acid powder mixture and a subsequent thermal decomposition reaction as a multi-step process (L. Shen et al., Chem. Lett. 32, 826 (2003)). A milling time of 3-6 hours was needed for the first and second reactions. This was followed by thermal decomposition at 400 to 600° C. The third reaction required a milling time of 30 minutes, followed by thermal decomposition of ZnC₂O₄.2H₂O at 450° C. Clearly, the calcination step consumes energy and prolongs the production cycle time.

Conventional methods of preparing zinc oxide nanoparticles often have disadvantages associated with the processes, such as, for example, lengthy milling preparation times and multiple process steps required to achieve initial zinc oxide nanoparticle synthesis. In addition, preparation of zinc oxide nanoparticles using conventional milling processes often generate aerosolized nanoparticles which create disadvantageous health or manufacturing concerns (H. F. Lecoanet et al., Environ. Sci. Technol. 38, 5164 (2004); G. Oberdorster et al., Environ. Health Perspect. 113, 823 (2004)).

### BRIEF SUMMARY OF THE INVENTION

An object of the present inventive subject matter is to provide a novel environmental friendly, time- and energy-saving mechanochemical process to synthesize ZnO nanoparticles and nanorods with minimized agglomeration of the primary particles.

According to the present subject matter, a mechanochemical reaction with as short a milling time as about 30 minutes for the synthesis of ZnO nanoparticles in one embodiment is disclosed. In this process, inorganic zinc salts are the sources of zinc. An alkali hydroxide, for example KOH or NaOH, is used as the base to change zinc salt to zinc oxide while an additional inorganic salt, for example KCl, NaCl or other inorganic salt, serves as the matrix salt. The reaction mixture is a paste. Thus, this would allay fears that nanoparticles would get airborne during the milling process and create disadvantageous health or manufacturing concerns.

One embodiment of the present subject matter relates to a process for preparing zinc oxide nanoparticles comprising grinding, milling, or a combination thereof a mixture comprising (a) at least one zinc salt, (b) at least one additional inorganic salt, and (c) at least one alkali hydroxide compound. In a particular embodiment, the present subject matter relates to a mechanochemical process for manufacturing zinc oxide nanoparticles without the need for using more than one process step.

In another embodiment, the present subject matter relates to a one-step process for manufacturing zinc oxide nanoparticles comprising grinding and/or milling. In one embodiment, the zinc oxide nanoparticles are made in a time as short as 30 minutes of grinding and/or milling.

In a further embodiment, the present subject matter relates to a process for preparing zinc oxide nanoparticles comprising grinding, milling, or a combination thereof a mixture consisting essentially of (a) at least one zinc salt, (b) at least one additional inorganic salt, and (c) at least one alkali hydroxide compound.

In one embodiment of the present subject matter relate to a process for preparing zinc oxide nanoparticles wherein by the mechanochemical process, the agglomeration of nanoparticles is minimized. In further embodiments described herein, the zinc oxide nanoparticles obtained are in the shape of spheres, short rods, and combinations thereof.

The present subject matter also relates to a composition comprising zinc oxide nanoparticles, wherein the zinc oxide nanoparticles are manufactured by the mechanochemical process described herein. The present subject matter also relates to a UV-screening composition comprising zinc oxide nanoparticles, wherein the zinc oxide nanoparticles are manufactured by the mechanochemical process described herein. In particular embodiments, the UV-screening composition comprising zinc oxide nanoparticles may be used as a protective feature for devices exposed to solar radiation or radiation generated by man-mad light sources. In other embodiments, the UV-screening composition comprising zinc oxide nanoparticles may be applied topically to the skin, hair, and keratin of an animal, such as a human, for example to protect them from the adverse effects of UV radiation.

### BRIEF DESCRIPTION OF THE DRAWINGS

FIG. 1A flowsheet showing one embodiment for producing ZnO nanoparticles.

FIG. 2 is an example TEM image of the zinc oxide nanoparticles sample produced by the method described in Example 1.

FIG. 3 is an example XRD pattern of the zinc oxide nanoparticles sample produced by the method described in Example 1.

FIG. 4 is an example XPS spectra of the zinc oxide nanoparticles sample produced by the method described in Example 1. (a) example of a survey scan in an energy range of 0-1100 eV; (b) example of a high resolution scan of the lines of Zn2p_{3/2}.

FIG. 5 is an example UV-Vis spectra for zinc oxide nanoparticles of our product produced by the method described in Example 1 and NanoZ_AQ40 nanoparticles from Advanced Nano.

FIG. 6 is an example XRD pattern of the zinc oxide nanoparticles sample produced by the method described in Example 3.

FIG. 7 is an example TEM image of zinc oxide nanoparticles sample produced by the method described in Example 3.

FIG. 8 is an example XRD pattern of the zinc oxide nanoparticles sample produced by the method described in Example 4.

FIG. 9 is an example TEM image of zinc oxide nanoparticles sample produced by the method described in Example 4.

### DETAILED DESCRIPTION OF THE SUBJECT MATTER

The inventive subject matter relates to a novel environmental friendly, time-saving, and energy-saving mechanochemical process to synthesize ZnO nanoparticles and nanorods with minimized agglomeration of the primary particles. By using such a mechanochemical process, a short milling time, as short as about 30 minutes, can be used to synthesize ZnO nanoparticles. In one embodiment of this process, the present subject matter relates to a process for preparing zinc oxide nanoparticles comprising grinding, milling, or a combination thereof a mixture comprising (a) at least one zinc salt, (b) at least one additional inorganic salt, and (c) at least one alkali hydroxide compound. In a particular embodiment, the present subject matter relates to a mechanochemical process for manufacturing zinc oxide nanoparticles without the need for using more than one process step. The reaction mixture is a paste, and thus minimizes the potential dangers of airborne nanoparticles.

As used herein, the phrase “ZnO or zinc oxide nanoparticle” means a small particle comprising ZnO as the major component, and wherein the particle has a spherical, semispherical, and short rod shape. “Nanoparticles” have a diameter ranging from 1 nm to several hundred nm. ZnO nanoparticles of many of the embodiments described herein will have a diameter of about 10 nm to 100 nm. In some embodiments, the diameter will range from about 20 to 50 nm, such as for example about 20 nm. “Diameter” of nanoparticles refers to the narrowest cross sectional diameter of a nanoparticle regardless of shape. “Nanorods” are nanoparticles that have a rod shape, including for example, rods with rounded ends and short rod shapes.

As used herein the phrase “zinc salt” refers to salts comprising zinc. These zinc salts are generally inorganic zinc salts and include hydrates of zinc salts. Non-limiting examples of such zinc salts include, for example, zinc sulfate, zinc nitrate, and zinc chloride. More particularly, the zinc salts may include zinc sulfate heptahydrate and zinc nitrate hexahydrate.

As used herein the phrase “additional inorganic salt” refers to any inorganic salt. Nonlimiting examples of such additional inorganic salts include, for example, of sodium chloride, potassium chloride, sodium sulfate, and potassium sulfate.

As used herein the phrase “alkali hydroxide” refers to alkaline sources of hydroxide ions. These alkali hydroxides include, for example but without limitation, lithium hydroxide (LiOH), sodium hydroxide (NaOH), potassium hydroxide (KOH), rubidium hydroxide (RbOH), and cesium hydroxide (CsOH). In particular, many embodiments use an alkali hydroxide selected from the group consisting of NaOH and KOH.

The mechanochemical process is recently being used to synthesize nanostructured materials. First of all, in some embodiments of the present subject matter, being an organic solvent-free process, it is attractive from an environmental point of view. Equally important, the nanoparticles formed in other embodiments of the present subject matter are well separated by an intervening salt matrix. In this way, agglomeration of nanoparticles encountered in the other synthesis methods may be minimized. This makes the dispersion of the synthesized products easier, which is important for the useful manufacture and application of nanoparticles. In addition, mechanochemical synthesis is particularly suitable for large-scale production because of its simplicity and low cost.

One embodiment of the present subject matter relates to a process for preparing zinc oxide nanoparticles comprising grinding, milling, or a combination thereof a mixture comprising (a) at least one zinc salt, (b) at least one additional inorganic salt, and (c) at least one alkali hydroxide compound. In a particular embodiment, the present subject matter relates to a mechanochemical process for manufacturing zinc oxide nanoparticles without the need for using more than one process step.

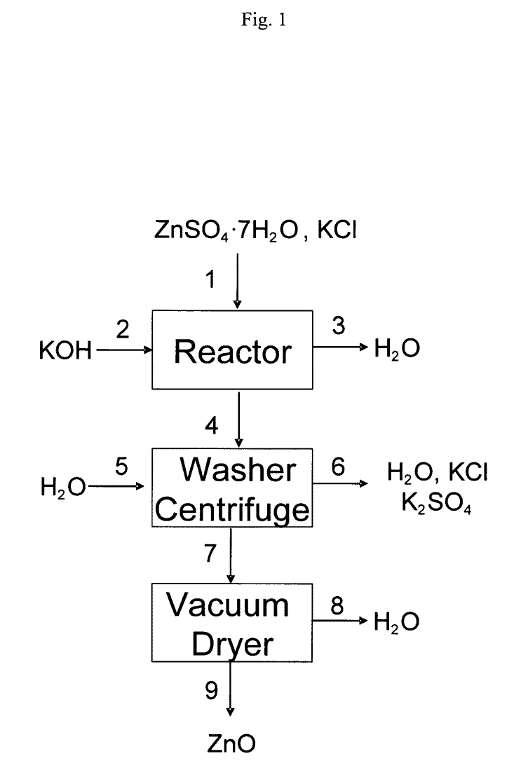

The flowsheet showing one embodiment for producing ZnO nanoparticles is shown in FIG. 1. This flowsheet is given as an example with ZnSO₄.7H₂O as zinc source, KCl as matrix salt and KOH as base. The numbered arrows indicate the sequential order of the process for this example. In the process, ZnSO₄.7H₂O and KCl were first added to the reactor, followed by the addition of KOH. ZnO nanoparticles were formed as a product of this one-step, and K₂SO₄ as byproduct. The reactor effluent was then centrifuged to remove the liquid phase, followed by washing to remove all KCl and K₂SO₄, which has a solubility of about one-third of that of KCl. The ZnO nanoparticles were then sent to a vacuum drier to remove all residual water.

In another embodiment, the present subject matter relates to a one-step process for manufacturing zinc oxide nanoparticles comprising grinding and/or milling. In one embodiment, the zinc oxide nanoparticles are made in a time as short as 30 minutes of grinding and/or milling. Additional ranges of grinding and/or milling times are also contemplated such as from about 30 minutes to several hours; from about 30 minutes to 2 hours; from about 30 minutes to one hour; and for less than one hour. Additional milling time might be needed in some embodiment, for example, to produce a narrower range of nanoparticle diameters.

In a further embodiment, the present subject matter relates to a process for preparing zinc oxide nanoparticles comprising grinding, milling, or a combination thereof a mixture consisting essentially of (a) at least one zinc salt, (b) at least one additional inorganic salt, and (c) at least one alkali hydroxide compound. In one embodiment, the process does not require more than one-process step to manufacture the zinc oxide nanoparticles. In one particular embodiment, a one-step process for synthesizing zinc oxide nanoparticles comprises grinding, milling, or a combination thereof a mixture comprising (a) at least one zinc salt, (b) at least one additional inorganic salt, and (c) at least one alkali hydroxide compound; wherein the one-step process comprises one continual grinding step wherein (a) and (b) are first added together and ground, followed by adding (c) to the (a) and (b) mixture and continuing to grind the composition to completion of synthesis of zinc oxide nanoparticles. Additional steps and processes may be added as needed to further purify or isolate varying degrees of pure zinc oxide nanoparticles. In one embodiment, the zinc oxide nanoparticles synthesized by the one-step process described herein are subsequently washed with water and optionally dried.

In particular embodiments described herein, the grinding, milling, or combination thereof is performed by a machine, such as, for example, using a mortar/ball-mill or a planetary ball-mill. Additional embodiments of the present subject matter relate to a process for preparing zinc oxide nanoparticles using at least one zinc salt selected from the group consisting of zinc sulfate, zinc nitrate, and zinc chloride. In particular embodiments described herein, the at least one zinc salt is selected from the group consisting of zinc sulfate heptahydrate and zinc nitrate hexahydrate.

Further embodiments of the present subject matter relate to a process for preparing zinc oxide nanoparticles using at least one additional inorganic salt useful as a salt matrix to prevent the growth and aggregation of the synthesized nanoparticles. In particular embodiments described herein, the at least one additional inorganic salt is selected from the group consisting of sodium chloride, potassium chloride, sodium sulfate, and potassium sulfate.

In other embodiments, the present subject matter relates to a process for preparing zinc oxide nanoparticles described herein wherein the at least one additional inorganic salt and at least one zinc salt form a matrix having a weight ratio of additional inorganic salt to zinc salt ranging from 0.2 to 5. In particular embodiments described herein, the at least one additional inorganic salt to at least one zinc salt matrix has a weight ratio ranging from 1 to 2.

Additional embodiments of the present subject matter relate to a process for preparing zinc oxide nanoparticles using at least one alkali hydroxide compound selected from the group consisting of lithium hydroxide (LiOH), sodium hydroxide (NaOH), potassium hydroxide (KOH), rubidium hydroxide (RbOH), and cesium hydroxide (CsOH).

An embodiment of the present subject matter relates to a process for preparing zinc oxide nanoparticles wherein by the mechanochemical process, the agglomeration of nanoparticles is minimized. In further embodiments described herein, the zinc oxide nanoparticles obtained are in the shape of spheres, short rods, and combinations thereof. In one embodiment, the zinc oxide nanoparticles obtained are in the shape of spheres. In particular embodiments described herein, the zinc oxide nanoparticles have a diameter ranging from about 10 nm to 100 nm, such as for example, ranging from about 20 nm to 50 nm. In one embodiment, the zinc oxide nanoparticles have a mean diameter of about 20 nm.

The present subject matter also relates to a composition comprising zinc oxide nanoparticles, wherein the zinc oxide nanoparticles are manufactured by the mechanochemical process described herein.

The present subject matter also relates to a UV-screening composition comprising zinc oxide nanoparticles, wherein the zinc oxide nanoparticles are manufactured by the mechanochemical process described herein. In particular embodiments, the UV-screening composition comprising zinc oxide nanoparticles may be used as a protective feature for devices exposed to solar radiation or radiation generated by man-made light sources. In other embodiments, the UV-screening composition comprising zinc oxide nanoparticles may be applied topically to the skin, hair, and keratin of an animal, such as a human, to protect them from the adverse effects of UV radiation. In yet other embodiments, the zinc oxide nanoparticles may be included in a variety of cosmetics and personal care products such as for example balms, shampoos, creams, and sprays. In another embodiment, the zinc oxide nanoparticles are used as a biocide, such as, for example, to eliminate and/or prevent microbial growth on surfaces, such as, growth of bacteria, fungi, or viruses.

Herein after, the present subject matter will be described in detail in examples with reference to the attached drawings. But the present subject matter is by no means limited to these specific Examples.

### Example 1

Solid powder of zinc sulfate heptahydrate and potassium chloride were mixed and ground in a mortar for a period of time. The weight ratio of potassium chloride to zinc sulfate heptahydrate varied from 1:5 to 5:1. Alternatively, the weight ratio was 1:1 or 2:1. The grinding time varied from 5 to 30 minutes. Alternatively, the grinding time was 10 to 15 minutes. During the grinding process, the sample became a white paste. Then, potassium hydroxide powder was added to the mixture and ground for another period of time at room temperature. The grinding time varied from 5 to 30 minutes. Alternatively, the grinding time was 10 to 20 minutes. The molar ratio of potassium hydroxide to zinc sulfate heptahydrate varied from 2:1. The combined grinding of the potassium chloride and zinc sulfate heptahydrate, and followed by the addition of potassium hydroxide and more grinding is, for the purposes of this subject matter, considered a one-step process for synthesizing the zinc oxide nanoparticles because the starting materials are combined in a continual manner and the intermediary addition of potassium hydroxide requires no additional manipulation of the starting grinding composition to synthesize the zinc oxide nanoparticles. After the grinding process, the mixture remained in a white paste state. The mixture was washed with double deionized (DDI) water by stirring, centrifugation and filtering until no chlorine ion could be detected. Then, the sample was vacuum dried at room temperature and collected for further characterization. The yield, defined as the ratio of the amount of zinc(II) in ZnO to that in ZnSO₄.7H₂O, varied from 93 to 98%.

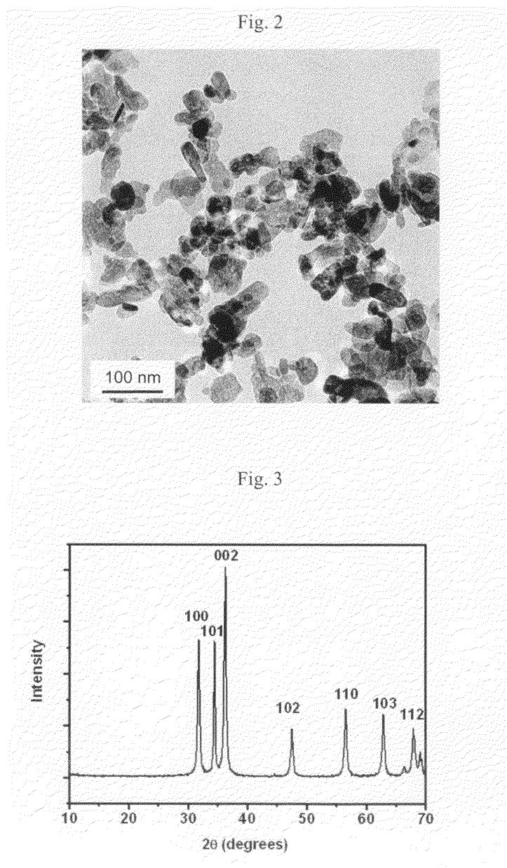

FIG. 2 shows the TEM image (JOEL JEM2010) of the obtained ZnO particulates which was synthesized under the following conditions: ZnSO₄.7H₂O was used as zinc salt, KCl as salt matrix and KOH as base. The weight ratio of KCl to ZnSO₄.7H₂O was 2:1 and molar ratio of KOH to ZnSO₄.7H₂O was 2:1. Zinc sulfate heptahydrate and potassium chloride were mixed and ground in a mortar for 10 minutes. Then, potassium hydroxide powder was added to the mixture and ground for 20 minutes at room temperature. It could be seen that the particles are dispersed and the particle sizes were all smaller than 100 nm and most of the particles were between 10 to 50 nm. The ZnO nanoparticles are subjected to further structural characterization with XRD (Philips PW-1830) and the results are shown in FIG. 3. Diffraction peaks at (100), (101), (002), (102), (110), (103) and (112) are readily recognized from the XRD pattern in FIG. 3. All the observed diffraction peaks are well indexed to the pure hexagonal phase of a wurtzite structure (JCPDS file No. 36-1451). An average particle size of 22.1 nm was obtained by using the Debye-Scherrer formula for spherical particles. This XRD result agreed well with the TEM images.

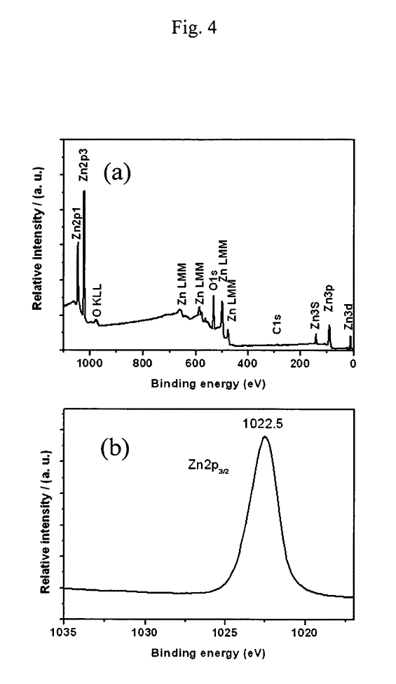

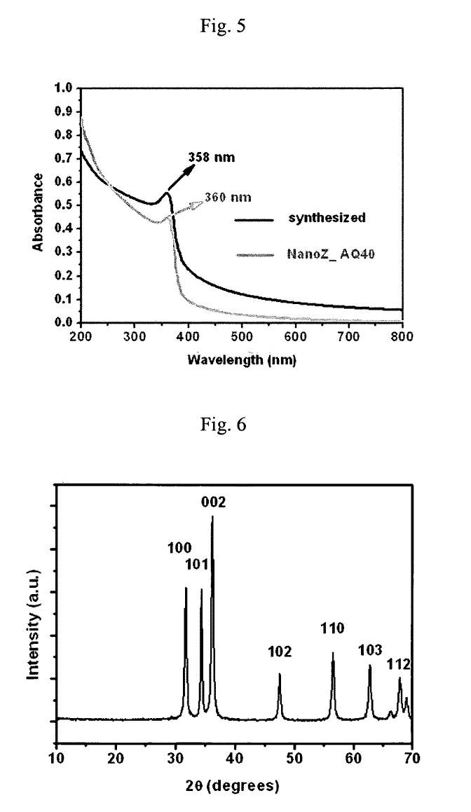

Purity is a very important characteristic of high quality ZnO nanoparticles especially for use in cosmetics. FIG. 4 shows the XPS spectra of ZnO nanoparticles (Physical Electronics 5600). It can be seen in FIG. 4(a) that in the whole region of 0-1100 eV, only the characteristic peaks of Zn2P_{1/2}, Zn2P_{3/2}, and O1s are presented. A full survey scan did not reveal any other element peaks except a very weak C1s peak, which comes from tiny amount of absorbed CO₂ on the sample surface. These results indicate that pure ZnO nanoparticles have formed. As shown in FIG. 4(b), the peak at the binding energy of 1022.5 eV corresponds to Zn2P_{3/2}.

Fine particles of metal oxides (e.g. titanium, zinc, zirconium, iron, etc.) are extensively used as agents to attenuate (absorb and/or scatter) the ultraviolet radiation having a wavelength of 290-400 nm. The zinc oxide powder attenuates more effectively the UV radiation in not only the UVB (290-320 nm) but also the UVA (320-400 nm) region and has a lower refractive index, of about 1.9, than other metal oxides.

The UV-blocking properties of our ZnO nanoparticles has been studied by UV-Vis spectrometer (Perkin Elmer Lanbda 20) characterization and compared with a commercial product. It could be seen that the curves of our sample and NanoZ_AQ40 (Advanced Nanotechnology Ltd., Welshpool, West Australia) exhibit excitonic absorption feature at around 358 and 360 nm respectively, which correspond to a band gap of 3.46 and 3.44 eV. The similar UV-Vis adsorption characteristics of our sample and NanoZ_AQ40 stem from their similar particle size and morphology. TEM characterization of NanoZ_AQ40 was also carried out. Most particles in the TEM images of NanoZ_AQ40 are composed of nanoparticles with particle size ranging from 20 to 50 nm. But there are also large irregular particles with particle size smaller than 80 nm. These characteristics are quite like those of the ZnO particles in FIG. 2.

### Example 2

ZnO nanoparticulates were prepared in the same manner used in Example 1 except that zinc nitrate hexahydrate was used instead of the zinc sulfate heptahydrate.

The XRD characterization showed the resulting products were ZnO with wurtzite structure. TEM images showed that the products had nearly with the same morphology as the ZnO nanoparticles described in Example 1.

### Example 3

Solid powder of zinc chloride, potassium chloride and a small amount of water were mixed and ground in a mortar for a period of time. The weight ratio of potassium chloride to zinc chloride varied from 1:5 to 5:1. Alternatively, the weight ratio is 1:1 or 2:1. The grinding time varied from 5 to 30 minutes. Alternatively, the grinding time was 10 to 15 minutes. During the grinding process, the sample became solution or white paste depending on the amount of water added. Then the mixture was left for 10 min. After this initial grinding process, potassium hydroxide powder was added to the mixture and ground for another period of time at room temperature. The grinding time varied from 5 to 30 minutes. Alternatively, the grinding time was 10 to 15 minutes. The molar ratio of potassium hydroxide to zinc chloride was 2:1. The combined grinding of the potassium chloride and zinc chloride, and followed by the addition of potassium hydroxide and more grinding is, for the purposes of this subject matter, considered a one-step process for synthesizing the zinc oxide nanoparticles because the starting materials are combined in a continual manner and the intermediary addition of potassium hydroxide requires no additional manipulation of the starting grinding composition to synthesize the zinc oxide nanoparticles. After the grinding process, the mixture remained in a white paste state. The mixture was washed with water and deionized water by stirring, centrifugation and filtering until no chlorine ion could be detected. Then, the sample was vacuum dried at room temperature and collected for further characterization. The yield, defined as the ratio of the amount of zinc(II) in ZnO to that in zinc chloride, varied from 92 to 96%.

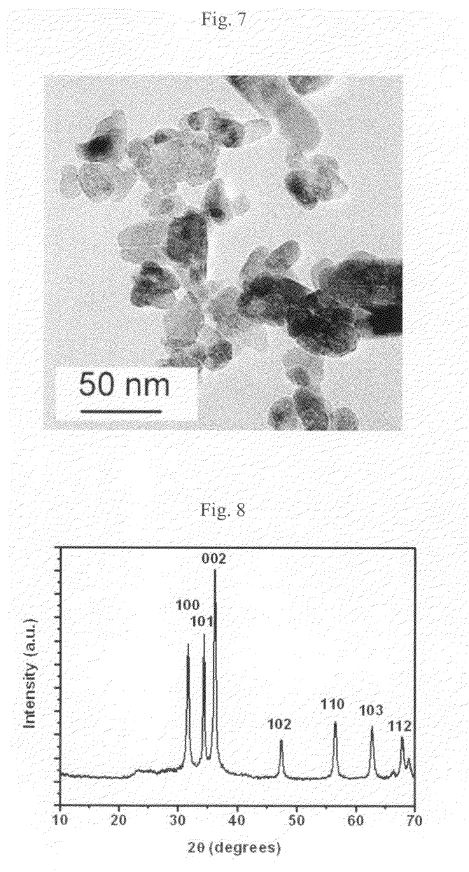

Presented in FIG. 6 is the XRD pattern of zinc oxide nanoparticles synthesized by this method, which is a typical sample of Example 3. The weight ratio of KCl to zinc chloride is 2:1 and molar ratio of KOH to zinc chloride was 2:1. Zinc chloride, small amount of water and potassium chloride were mixed and ground in a mortar for 10 minutes. Then, potassium hydroxide powder was added to the mixture and ground for 20 minutes at room temperature. The XRD pattern show that the product was pure hexagonal phase of a wurtzite structure (JCPDS file No. 36-1451). Shown in FIG. 7 is the TEM image of this sample. It shows that the resulting products had nearly the same morphology and particle size as in FIG. 2 which was produced by the method described in Example 1.

### Example 4

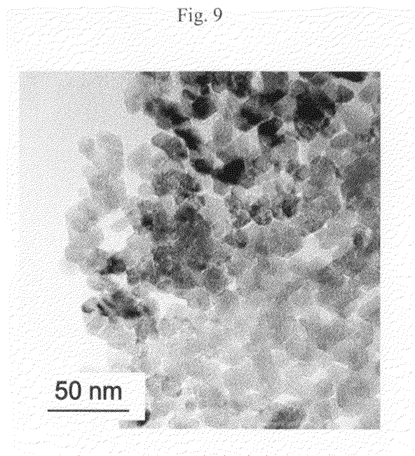

ZnO nanoparticles could also be synthesized by a planetary ball mill with similar weight ratio of potassium chloride to zinc sulfate heptahydrate, similar molar ratio of potassium hydroxide to zinc sulfate heptahydrate and similar milling time as stated in EXAMPLES before. The nanoparticles produced by planetary ball mill have smaller particle size compared with those produced by a mortar and pestle. A typical process is as follows: the weight ratio of KCl to ZnSO₄.7H₂O is 2:1 and molar ratio of KOH to ZnSO₄.7H₂O is 2:1. Zinc sulfate heptahydrate and potassium chloride were mixed by a planetary ball mill for 10 minutes. The ratio of the weight of the milling balls to the total weight of potassium and zinc sulfate heptahydrate is 3:1. Then, potassium hydroxide powder was added to the mixture and ground for 10 minutes in the planetary ball mill at room temperature. The combined grinding of the potassium chloride and zinc sulfate heptahydrate, and followed by the addition of potassium hydroxide and more grinding is, for the purposes of this subject matter, considered a one-step process for synthesizing the zinc oxide nanoparticles because the starting materials are combined in a continual manner and the intermediary addition of potassium hydroxide requires no additional manipulation of the starting grinding composition to synthesize the zinc oxide nanoparticles. Shown in FIG. 8 is the XRD pattern of zinc oxide nanoparticles synthesized by this method, which is a typical sample of Example 4. The XRD pattern shows that product is also of a wurtzite structure (JCPDS file No. 36-1451). FIG. 9 is the TEM image of the nanoparticles produced by this method. It could be seen that the resulting ZnO nanoparticles had a size within a range from 5 to 20 nm and in most cases the particle sizes were near 10 nm.

Having described the subject matter in detail and by reference to the embodiments thereof, it will be apparent that modifications and variations are possible, including the addition of elements or the rearrangement or combination or one or more elements, without departing from the scope of the subject matter which is defined in the appended claims. Thus, the present subject matter is not intended to be limited to the embodiments shown herein but is to be accorded the widest scope consistent with the principles and novel features disclosed herein.

The following publications are incorporated herein by reference in their entirety for all purposes:

U.S. Patent Documents

| | | |
|---|---|---|
| 6,171,580 | July 1999 | Katsuyama |
| 5,527,519 | June 1996 | Miksits |
| 5,560,871 | October 1996 | Yoshimaru |
| 5,582,771 | December 1996 | Yoshimaru |
| 6,416,862 | July 2002 | Kogoi |
| 6,335,002 | January 2002 | Kogoi |
| 6,503,475 | January 2003 | McCormick |

### OTHER REFERENCES

D. C. Reynolds et al., J. Appl. Phy. 88, 2152 (2000).
J. H. Lim et al., Adv. Mater. 18, 2720 (2006).
M. T. Mohammad et al., Mater. Chem. Phys 99, 382 (2006).
A. B. G. Lansdown et al., Int. J. Cosmet. Sci. 19, 167 (1997).
F. A. Sigoli et al., J. Alloys Compd., 262, 292 (1997).
S. Mahmud et al., J. Cryst. Growth 287, 118 (2006).
T. Tsuzuki et al., Scripta Mater. 44, 1731 (2001).
H. M. Yang et al., Mater. Sci. Technol., 20, 1493 (2004).
R. Radoi et al., Nanotechnology, 14, 794 (2003).
L. C. Damonte et al., Powder Technol., 148, 15 (2004).
L. Shen et al., Chem. Lett., 32, 826 (2003).
H. F. Lecoanet et al., Environ. Sci. Technol. 38, 5164 (2004).
G. Oberdorster et al., Environ. Health Perspect. 113, 823 (2004).

We claim:

1. A process for preparing zinc oxide nanoparticles comprising grinding, milling, or a combination thereof a mixture comprising (a) at least one zinc salt, (b) at least one additional inorganic salt, and (c) at least one alkali hydroxide compound.

2. The process as claimed in claim 1, wherein the mixture consists essentially of (a) at least one zinc salt, (b) at least one additional inorganic salt, and (c) at least one alkali hydroxide compound.

3. The process as claimed in claim 1, wherein the grinding, milling, or combination thereof is performed by a machine.

4. The process as claimed in claim 3, wherein the machine for grinding, milling, or combination thereof is selected from the group consisting of a mortar/ball-mill and a planetary ball-mill.

5. The process as claimed in claim 1, wherein the at least one zinc salt is selected from the group consisting of zinc sulfate, zinc nitrate, and zinc chloride

6. The process as claimed in claim 5, wherein the at least one zinc salt is selected from the group consisting of zinc sulfate heptahydrate and zinc nitrate hexahydrate.

7. The process as claimed in claim 1, wherein the at least one additional inorganic salt is used as salt matrix to prevent the growth and aggregation of the synthesized nanoparticles.

8. The process as claimed in claim 1, wherein the at least one additional inorganic salt is selected from the group consisting of sodium chloride, potassium chloride, sodium sulfate, and potassium sulfate.

9. The process as claimed in claim 1, wherein the at least one additional inorganic salt and at least one zinc salt form a matrix having a weight ratio of additional inorganic salt to zinc salt ranging from 0.2 to 5.

10. The process as claimed in claim 9, wherein the at least one additional inorganic salt to at least one zinc salt matrix has a weight ratio ranging from 1 to 2.

11. The process as claimed in claim 1, wherein the at least one alkali hydroxide compound is selected from the group consisting of lithium hydroxide (LiOH), sodium hydroxide (NaOH), potassium hydroxide (KOH), rubidium hydroxide (RbOH), and cesium hydroxide (CsOH).

12. The process as claimed in claim 1, wherein by the mechanochemical process minimizes the agglomeration of nanoparticles.

13. The process as claimed in claim 1, wherein the zinc oxide nanoparticles obtained are in the shape of spheres, short rods, and combinations thereof.

14. The process as claimed in claim 1, wherein the zinc oxide nanoparticles obtained are in the shape of spheres.

15. The process as claimed in claim 1, wherein the zinc oxide nanoparticle diameter ranges from about 5 nm to 100 nm.

16. The process as claimed in claim 1, wherein the zinc oxide nanoparticle diameter ranges from about 20 nm to 50 nm.

17. The process as claimed in claim 1, wherein the zinc oxide nanoparticles' mean diameter is about 20 nm.

18. A composition comprising zinc oxide nanoparticles, wherein the zinc oxide nanoparticles are manufactured by the process according to claim 1.

19. A UV-screening composition comprising zinc oxide nanoparticles manufactured by the process according to claim 1.

20. A one-step process for synthesizing zinc oxide nanoparticles comprising grinding, milling, or a combination thereof a mixture comprising (a) at least one zinc salt, (b) at least one additional inorganic salt, and (c) at least one alkali hydroxide compound; wherein the one-step process comprises one continual grinding step wherein (a) and (b) are first added together and ground, followed by adding (c) to the (a) and (b) mixture and continuing to grind the composition to completion of synthesis of zinc oxide nanoparticles.

21. The one-step process as claimed in claim 20, wherein the zinc oxide nanoparticles are synthesized in 30 minutes after beginning the grinding time of (a) and (b).

22. The one-step process as claimed in claim 20, wherein the zinc oxide nanoparticles synthesized by the one-step process are subsequently washed with water and optionally dried.
